(19) United States
(12) Patent Application Publication
(10) Pub. No.: US 2016/0062518 A1
(43) Pub. Date: Mar. 3, 2016

(54) TOUCH SUBSTRATE AND FABRICATING METHOD THEREOF, AND TOUCH DISPLAY APPARATUS

(71) Applicants: BOE Technology Group Co., Ltd., Beijing (CN); Hefei Xinsheng Optoelectronics Technology Co., Ltd., Hefei City, Anhui (CN)

(72) Inventors: Xianlin DING, Beijing (CN); Ming HU, Beijing (CN)

(21) Appl. No.: 14/770,622

(22) PCT Filed: Nov. 14, 2014
(86) PCT No.: PCT/CN2014/091128

§ 371 Date: Aug. 26, 2015

(30) Foreign Application Priority Data
Aug. 29, 2014 (CN) 201410437952.X

(51) Int. Cl. G06F 3/047; G06F 3/044

(52) U.S. Cl. CPC G06F 3/047; G06F 3/044; G06F 2203/04103

(57) ABSTRACT

A touch substrate, a fabricating method of a touch substrate and a touch display apparatus are disclosed. The touch substrate includes a first electrode layer and a second electrode layer which are arranged on a base substrate; the first electrode layer includes a plurality of first electrodes, the second electrode layer includes a plurality of second electrodes, each of the first electrodes includes a plurality of first electrode units and first connecting portions connected between every two adjacent first electrode units, each of the second electrodes includes a plurality of second electrode units and second connecting portions connected between every two adjacent second electrode units, and the first connecting portions and the second connecting portions are insulated and intersected with each other. The first electrode units are transparent electrode blocks, and the second electrode units are wire gauze electrode blocks.

### TECHNICAL FIELD

Embodiments of the present disclosure relate to a touch substrate and a fabricating method thereof as well as a touch display apparatus comprising the touch substrate.

### BACKGROUND

The touch technology, as one of most convenient human-computer interaction technologies, has become gradually popular in human life. A capacitive touch screen is one important form of a touch screen, a touch substrate of the capacitive touch screen comprises a drive electrode layer and a sensing electrode layer, a plurality of drive electrodes of the drive electrode layer and a plurality of sensing electrodes of the sensing electrode layer are intersected with each other, capacitance is generated at a place where two kinds of electrodes are adjacent; each drive electrode is loaded with a drive signal in a scanning manner, each sensing electrode generates a corresponding sensing signal, and when a touch action occurs, a human body or a touch pen approaches a touch region, such that the capacitance between the sensing electrode and the drive electrode in this region changes, thereby enabling the sensing signal of the corresponding sensing electrode to change and further determine the position of the touch action.

A one glass solution (OGS) technology makes the drive electrode layer and the sensing electrode layer on one substrate, which is beneficial to lighting and thinning a touch substrate, thereby becoming one of most promising touch technologies. However, this technology is restricted in size. In a case of a large size, if the sensing electrode is made from indium tin oxide (ITO), the resistance of the sensing electrode is relatively large, and signal attenuation is increased, so that the signal processing is more difficult; and meanwhile, the scanning frequency of the touch substrate is reduced due to an increase of the resistance.

### SUMMARY

According to an embodiment of the present disclosure, there is provided a touch substrate. The touch substrate comprises a first electrode layer and a second electrode layer which are arranged on a base substrate; the first electrode layer includes a plurality of first electrodes, the second electrode layer includes a plurality of second electrodes, each of the first electrodes includes a plurality of first electrode units and first connecting portions connected between every two adjacent first electrode units, each of the second electrodes includes a plurality of second electrode units and second connecting portions connected between every two adjacent second electrode units, and the first connecting portions and the second connecting portions are insulated and intersected. The first electrode units are transparent electrode blocks, and the second electrode units are wire gauze electrode blocks.

For example, the wire gauze electrode blocks each include a plurality of first metal wires extending along a first direction and a plurality of second metal wires extending along a second direction, and the plurality of first metal wires and the plurality of second metal wires are intersected to form a latticed structure.

For example, the first electrodes are drive electrodes, and the second electrodes are sensing electrodes.

For example, the first electrodes extend along a width direction of the base substrate, and the second electrodes extend along a length direction of the base substrate.

For example, a material for fabricating the wire gauze electrode blocks includes copper or aluminum.

For example, a material for fabricating the transparent electrode blocks includes indium tin oxide.

For example, a transparent insulating layer is arranged between the first electrode layer and the second electrode layer.

For example, the touch substrate further comprises a transparent protective layer arranged above the first electrode layer and the second electrode layer.

According to an embodiment of the present disclosure, there is provided a fabricating method of a touch substrate. The fabricating method comprises: providing a base substrate; forming a first electrode layer comprising a plurality of first electrodes and a second electrode layer comprising a plurality of second electrodes on the base substrate. A process of forming each of the first electrodes includes: forming a plurality of first electrode units sequentially arranged and forming first connecting portions connected between every two adjacent first electrode units; a process of forming the second electrode includes: forming a plurality of second electrode units sequentially arranged and forming second connecting portions connected between every two adjacent second electrode units, the first connecting portions and the second connecting portions being intersected with each other, the first electrode units being transparent electrode blocks, and the second electrode units being wire gauze electrode blocks.

For example, forming of the second electrode units includes: forming a plurality of a plurality of first metal wires extending along a first direction and a plurality of second metal wires extending along a second direction; the plurality of first metal wires and the plurality of second metal wires are intersected to form a latticed structure.

For example, the first electrodes are drive electrodes, and the second electrodes are sensing electrodes.

For example, the first electrodes extend along a width direction of the base substrate, and the second electrodes extend along a length direction of the base substrate.

For example, a material for fabricating the wire gauze electrode blocks includes copper or aluminum.

For example, a material for fabricating the transparent electrode blocks includes indium tin oxide.

For example, the fabricating method further comprises: forming a transparent insulating layer between the first electrode layer and the second electrode layer.

For example, the fabricating method further comprises: forming a transparent protective layer on the base substrate where the first electrode layer and the second electrode layer are formed.

According to an embodiment of the present disclosure, there is provided a touch display apparatus. The touch display apparatus comprises a display panel and any touch substrate as described above.

For example, the display panel includes an array substrate and an opposed substrate arranged opposite to the array substrate, and the base substrate of the touch substrate serves as a base substrate of the opposed substrate.

### BRIEF DESCRIPTION OF THE DRAWINGS

In order to more clearly illustrate the technical solution of the embodiments of the present disclosure, the drawings of the embodiments will be briefly described in the following; it is obvious that the described drawings are only related to some embodiments of the present disclosure and thus are not limitative of the present disclosure.

FIG. 1 is a cross-sectional view of a touch substrate according to an embodiment of the present disclosure;

FIG. 2 is a schematic distribution view of a second electrode in the touch substrate according to the embodiment of the present disclosure; and

FIG. 3 is a top view of the touch substrate according to the embodiment of the present disclosure.

### DETAILED DESCRIPTION

In order to make objects, technical details and advantages of the embodiments of the present disclosure apparent, the technical solutions of the embodiments of the present disclosure will be described in a clearly and fully understandable way in connection with the drawings. It is obvious that the described embodiments are just a part but not all of the embodiments of the present disclosure. Based on the described embodiments of the present disclosure, those ordinarily skilled in the art can obtain other embodiment(s), without any inventive work, which should be within the protective scope of the present disclosure.

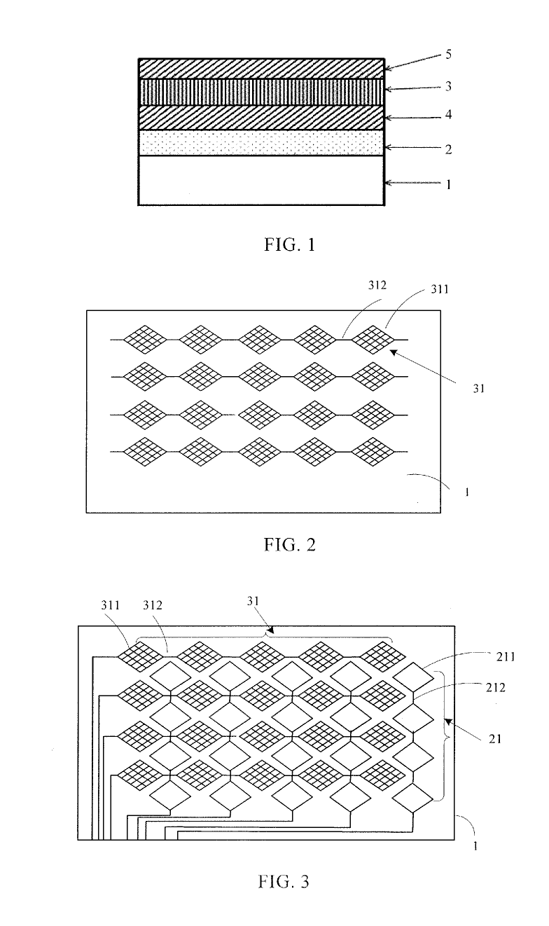

An embodiment of the present disclosure provides a touch substrate. As shown in FIG. 1 to FIG. 3, the touch substrate comprises a first electrode layer 2 and a second electrode layer 3 which are arranged on a base substrate 1; the first electrode layer 2 includes a plurality of first electrodes 21, the second electrode layer 3 includes a plurality of second electrodes 31, each of the first electrodes 21 includes a plurality of first electrode units 211 and first connecting portions 212 connected between every two adjacent first electrode units 211, each of the second electrodes 31 includes a plurality of second electrode units 311 and second connecting portions 312 connected between every two adjacent second electrode units 311, and the first connecting portions 212 and the second connecting portions 312 are insulated and intersected with each other, the first electrode units 211 are transparent electrode blocks, and the second electrode units 311 are wire gauze electrode blocks.

For example, the wire gauze electrode blocks each includes a plurality of first metal wires extending along a first direction and a plurality of second metal wires extending along a second direction, the plurality of first metal wires and the plurality of second metal wires are intersected with each other to form a latticed structure, and latticed structures are connected to form a second electrode 31. The present disclosure does not limit the first direction and the second direction, as long as the first metal wires and the second metal wires can be intersected to form a lattice/network.

The resistance of the wire gauze electrode block is smaller than that of the transparent electrode block. Therefore, if the size of the base substrate is given, in comparison with the case where the first electrode unit 211 and the second electrode unit 311 are transparent electrode blocks, in the embodiment of the present disclosure, the first electrode unit 211 is provided as a transparent electrode block and the second electrode unit 311 is provided as a wire gauze electrode block, the total resistance of the electrodes decreases, and therefore, the attenuation degree of a signal can be reduced, the scanning frequency of the touch substrate is prevented from being reduced due to overlarge resistance, and fabricating of a large-sized touch screen is facilitated. On the other hand, if the first electrode unit 211 and the second electrode unit 311 both are wire gauze electrode blocks, included angles produced between metal wires of the wire gauze electrode block enables light rays penetrating through the two layers of electrodes to suffer from the light diffraction phenomenon; nevertheless the embodiment of the present disclosure is simultaneously provided with the wire gauze electrode block and the transparent electrode block, the number of the wire gauze electrode blocks on the whole touch substrate can be reduced, and the number of the included angles produced between the metal wires of the wire gauze metal blocks is reduced as well, so that the light diffraction phenomenon is reduced, and further the moire effect is alleviated. It will be appreciated by those skilled in the art that, the touch substrate provided by the embodiment of the present disclosure is suitable for a capacitive touch screen, and therefore, the first electrode 21 is mutually insulated from the second electrode 31, so that in response to that a drive module provides a drive voltage to the touch substrate, capacitance can be generated between the first electrode 21 and the second electrode 31.

Shapes of the first electrode unit 211 and the second electrode unit 311 may be same, for example, shapes of the first electrode unit 211 and the second electrode unit 311 may both be of a diamond, the vertexes of two diamonds of two adjacent first electrode units 211 are connected through a first connecting portion 212, and the vertexes of two diamonds of two adjacent second electrode units 311 are connected through a second connecting portion 312, so that patterns of the electrodes on the touch substrate are relatively regular. Certainly, the first electrode unit 211 and the second electrode unit 311 may have other shapes.

In the embodiment of the present disclosure, the first electrode 21 may act as a sensing electrode, or the second electrode 31 may act as a sensing electrode. For example, the first electrode 21 serves as a drive electrode, and the second electrode 31 serves as a sensing electrode. In this case, the sensing electrode includes a plurality of wire gauze electrode blocks with smaller resistance, the signal attenuation occurred over the sensing electrode layer can be reduced; the drive electrode is generally connected with a drive module configured for driving the touch substrate, and the drive module may provide a larger drive voltage to the drive electrode, so that the signal attenuation caused by overlarge resistance of the drive electrode can be reduced.

In order to further reduce the total resistance of the electrode of the touch substrate, for example, the first electrode 21 serves as a drive electrode and includes a plurality of transparent electrode blocks, and the second electrode 31 serves as a sensing electrode, and includes a plurality of wire gauze electrode blocks; the first electrode 21 extends along a width direction of the base substrate 1, and the second electrode 31 extends along a length direction of the base substrate 1, so that a small number of the transparent electrode blocks with larger resistances are arranged in each row, the resistance of the drive electrode is reduced, and thus the signal attenuation is alleviated; meanwhile, a refreshing frequency of the touch substrate is prevented from being reduced due to overlarge resistance, and the touch sensitivity is improved.

A material for fabricating the wire gauze electrode block may be any one of metals such as copper, iron, aluminum and silver, and may also be an alloy thereof. In order to make the wire gauze electrode block have excellent electrical conductivity and lower cost, for example, a material for fabricating the first metal wire and the second metal wire includes copper or aluminum.

A material for fabricating the transparent electrode block may include indium tin oxide (ITO).

As described above, the first electrode layer 2 and the second electrode layer 3 are spaced in an insulation manner. Therefore, as shown in FIG. 1, the touch substrate according to the embodiment of the present disclosure further comprises a transparent insulating layer 4 arranged between the first electrode layer 2 and the second electrode layer 3, and the transparent insulating layer 4 functions as an insulating layer, and may not affect transmission of light of the touch substrate.

As shown in FIG. 1, the touch substrate further comprises a transparent protective layer 5 arranged above the first electrode layer 2 and the second electrode layer 3 so as to protect the first electrode layer 2 and the second electrode layer 3. The transparent protective layer 5 and the transparent insulating layer 4 may be made of a same transparent insulation material.

The above is description of the touch substrate provided by the embodiment of the present disclosure, and it may be understood that the resistance of the wire gauze electrode block is relatively small, so if the second electrode unit is the wire gauze electrode block, the total resistance of the electrodes on the touch substrate can be reduced, such that where the size of the touch substrate is relatively large, the signal attenuation caused by overlarge resistance of the electrodes of the touch substrate is reduced, and fabricating of a large-sized touch screen is facilitated; meanwhile, the first electrode unit is the transparent electrode block, so that diffraction of the light rays between the wire gauze electrode blocks is reduced, and further the moire effect is reduced. When the drive electrode is a transparent electrode with larger resistance, the drive electrode extends along the width direction of the base substrate, so that the resistance of the drive electrode is further reduced, the signal attenuation is reduced, the scanning frequency of the touch substrate is prevented from being affected by overlarge resistance, and the touch control sensitivity is provided.

An embodiment of the present disclosure further provides a fabricating method of a touch substrate, the fabricating method comprises: providing a base substrate; forming a first electrode layer comprising a plurality of first electrodes and a second electrode layer comprising a plurality of second electrodes on the base substrate.

The process of forming each of the first electrodes includes: forming a plurality of first electrode units sequentially arranged and forming first connecting portions connected between every two adjacent first electrode units; the process of forming the second electrode includes: forming a plurality of second electrode units sequentially arranged and forming second connecting portions connected between every two adjacent second electrode units. The first connecting portions and the second connecting portions are intersected with each other, the first electrode units are transparent electrode blocks, and the second electrode units are wire gauze electrode blocks.

For example, the method further comprises: forming a transparent protective layer on the base substrate where the first electrode layer and the second electrode layer are formed. For example, the transparent protective layer may be formed in a depositing or coating manner.

For example, the process of forming the second electrode units includes: forming a plurality of first metal wires extending along a first direction and a plurality of second metal wires extending along a second direction, and the plurality of first metal wires and the plurality of second metal wires are intersected to form a latticed structure.

Particularly, the process of forming a first electrode layer comprising a plurality of first electrodes and a second electrode layer comprising a plurality of second electrodes on the base substrate may include: forming a transparent conductive layer on the base substrate; forming a first electrode by a patterning process so as to form the first electrode layer, wherein a material for forming the transparent conductive layer may be indium tin oxide (ITO); forming a transparent insulating layer on the base substrate where the first electrode is formed, wherein the transparent insulating layer may be formed in a vapor depositing or coating manner; forming a metal material layer on the base substrate where the first electrode and the transparent insulating layer have been formed, and forming a plurality of second electrodes by a patterning process so as to form the second electrode layer, wherein a material for forming the metal material layer may be copper or aluminum.

In the fabricating process of the touch substrate, the patterning process may employ a photolithography process. A method for forming the first electrode layer includes: firstly, cleaning the base substrate, and depositing a transparent material layer (ITO thin film); then, forming a positive photoresist layer, for example, on the transparent electrode layer, exposing the photoresist layer with a mask plate, wherein a pattern of the mask plate is consistent with that of the first electrode, that is, the mask plate has a plurality of patterns of the first electrode units and the first connecting portions; developing the exposed photoresist layer, removing a photoresist modified by exposure while remaining the photoresist which is not exposed to light, and performing a high-temperature treatment on the base substrate to enable the photoresist layer to become relatively hard; then, removing a portion, which is not covered by the photoresist, of the thin film of the transparent material layer by using a proper etching liquid; and finally, stripping off the photoresist layer to obtain the first electrode layer. A process of forming the second electrode layer is identical with that for forming the first electrode layer, which will not be described in detail herein.

For example, the first electrode extends along a width direction of the base substrate, the second electrode extends along a length direction of the base substrate, that is, when the first electrode is formed, an extending direction of the pattern corresponding to the first electrode on the mask plate is consistent with the width direction of the base substrate; when the second electrode is formed, an extending direction of the pattern corresponding to the second electrode on the mask plate is consistent with the length direction of the base substrate.

An embodiment of the present disclosure further provides a touch display apparatus, comprising a display panel and the touch substrate provided by the present disclosure. As the total resistance of the electrodes on the touch substrate provided by the embodiment of the present disclosure is reduced, it may be applied to a touch display apparatus of a larger size, and the moire effect is alleviated. Therefore, the size of the touch display apparatus provided by the embodiment of the present disclosure may be increased, the moire effect is alleviated, and the display quality is improved.

For example, the display panel may comprise an array substrate and an opposed substrate arranged opposite to the array substrate, the base substrate of the touch substrate may serve as a base substrate of the opposed substrate, so that a thickness of the touch display apparatus is reduced.

For example, the touch display apparatus may be any product or component having a display function, such as a liquid crystal display panel, an OLED panel, a cellphone, a tablet personal computer, a television, a monitor, a laptop, a digital photo frame, and a navigator.

The foregoing embodiments merely are exemplary embodiments of the present disclosure, and not intended to define the protective scope of the present disclosure, and the protective scope of the present disclosure is determined by the appended claims.

This application claims the benefit of China Patent Application No. 201410437952.X, filed on Aug. 29, 2014, the disclosure of which is incorporated herein by reference in its entirety as part of the present application.

1. A touch substrate, comprising a first electrode layer and a second electrode layer which are arranged on a base substrate, the first electrode layer including a plurality of first electrodes, the second electrode layer including a plurality of second electrodes, each of the first electrodes including a plurality of first electrode units and first connecting portions connected between every two adjacent first electrode units, each of the second electrodes including a plurality of second electrode units and second connecting portions connected between every two adjacent second electrode units, and the first connecting portions and the second connecting portions being insulated and intersected, wherein,
the first electrode units are transparent electrode blocks, and the second electrode units are wire gauze electrode blocks.

2. The touch substrate according to claim 1, wherein the wire gauze electrode blocks each includes a plurality of first metal wires extending along a first direction and a plurality of second metal wires extending along a second direction, and the plurality of first metal wires and the plurality of second metal wires are intersected to form a latticed structure.

3. The touch substrate according to claim 1, wherein the first electrodes are drive electrodes, and the second electrodes are sensing electrodes.

4. The touch substrate according to claim 3, wherein the first electrodes extend along a width direction of the base substrate, and the second electrodes extend along a length direction of the base substrate.

5. The touch substrate according to claim 1, wherein a material for fabricating the wire gauze electrode blocks includes copper or aluminum.

6. The touch substrate according to claim 1, wherein a material for fabricating the transparent electrode blocks includes indium tin oxide.

7. The touch substrate according to claim 1, wherein a transparent insulating layer is arranged between the first electrode layer and the second electrode layer.

8. The touch substrate according to claim 1, wherein the touch substrate further comprises a transparent protective layer arranged above the first electrode layer and the second electrode layer.

9. A fabricating method of a touch substrate, comprising:
providing a base substrate;
forming a first electrode layer comprising a plurality of first electrodes and a second electrode layer comprising a plurality of second electrodes on the base substrate, wherein,
a process of forming each of the first electrodes includes: forming a plurality of first electrode units sequentially arranged and forming first connecting portions connected between every two adjacent first electrode units;
a process of forming the second electrodes includes: forming a plurality of second electrode units sequentially arranged and forming second connecting portions connected between every two adjacent second electrode units, the first connecting portions and the second connecting portions being intersected with each other, the first electrode units being transparent electrode blocks, and the second electrode units being wire gauze electrode blocks.

10. The fabricating method of the touch substrate according to claim 9, wherein forming of the second electrode units comprises:
forming a plurality of first metal wires extending along a first direction and a plurality of second metal wires extending along a second direction, the plurality of first metal wires and the plurality of second metal wires being intersected with each other to form a latticed structure.

11. The fabricating method of the touch substrate according to claim 9, wherein the first electrodes are drive electrodes, and the second electrodes are sensing electrodes.

12. The fabricating method of the touch substrate according to claim 11, wherein the first electrodes extend along a width direction of the base substrate, and the second electrodes extend along a length direction of the base substrate.

13. The fabricating method of the touch substrate according to claim 9, wherein a material for fabricating the wire gauze electrode blocks includes copper or aluminum.

14. The fabricating method of the touch substrate according to claim 9, wherein a material for fabricating the transparent electrode blocks includes indium tin oxide.

15. The fabricating method of the touch substrate according to claim 9, further comprising:
forming a transparent insulating layer between the first electrode layer and the second electrode layer.

16. The fabricating method of the touch substrate according to claim 9, further comprising:
forming a transparent protective layer on the base substrate where the first electrode layer and the second electrode layer are formed.

17. A touch display apparatus, comprising a display panel and the touch substrate according to claim 1.

18. The touch display apparatus according to claim 17, wherein the display panel includes an array substrate and an opposed substrate arranged opposite to the array substrate, and the base substrate of the touch substrate serves as a base substrate of the opposed substrate.

19. The touch display apparatus according to claim 17, wherein the wire gauze electrode blocks each includes a plurality of first metal wires extending along a first direction and a plurality of second metal wires extending along a second direction, and the plurality of first metal wires and the plurality of second metal wires are intersected to form a latticed structure.

20. The touch display apparatus according to claim 17, wherein the first electrodes are drive electrodes, and the second electrodes are sensing electrodes.
